(19) United States
(12) Patent Application Publication
(10) Pub. No.: US 2009/0044350 A1
(43) Pub. Date: Feb. 19, 2009

(54) DYING-STABLE MODIFICATION OF QUINOPHTHALONE DISPERSE DYE, THE PRODUCTION THEREOF AND ITS USE

(75) Inventor: Hartwig Jordan, Bergisch-Gladbach (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/658,988

(22) PCT Filed: Aug. 2, 2005
(86) PCT No.: PCT/EP2005/053776

§ 371 Date: Aug. 29, 2008

(30) Foreign Application Priority Data
Aug. 6, 2004 (DE) 10 2004 038 267.0

(51) Int. Cl. C09B 25/00; C09D 11/02

(52) U.S. Cl. 8/658; 546/154; 106/31.47

(57) ABSTRACT

β-Form of the dye of the formula (I)

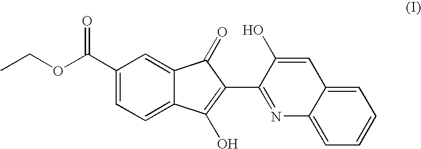

production of the β-form, which is stable to dyeing, and its use for dyeing and printing textile materials composed of polyester and/or cellulose esters or blend fabrics of these materials with wool or cellulose.

The present invention relates to a stable crystal form (β-form) of the dye of the formula (I)

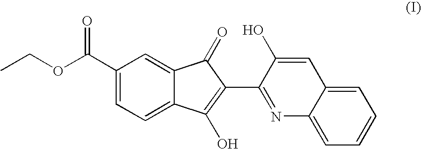

characterized by x-ray diffraction diagram (Cu—K_{α} radiation) lines at the following diffraction angles 2θ (°):
lines of high intensity:
8.0, 11.9, 13.0
lines of medium intensity:
10.7, 12.2, 16.0, 17.1, 18.7, 20.3, 24.5, 25.0, 26.0, 26.7, 29.5.

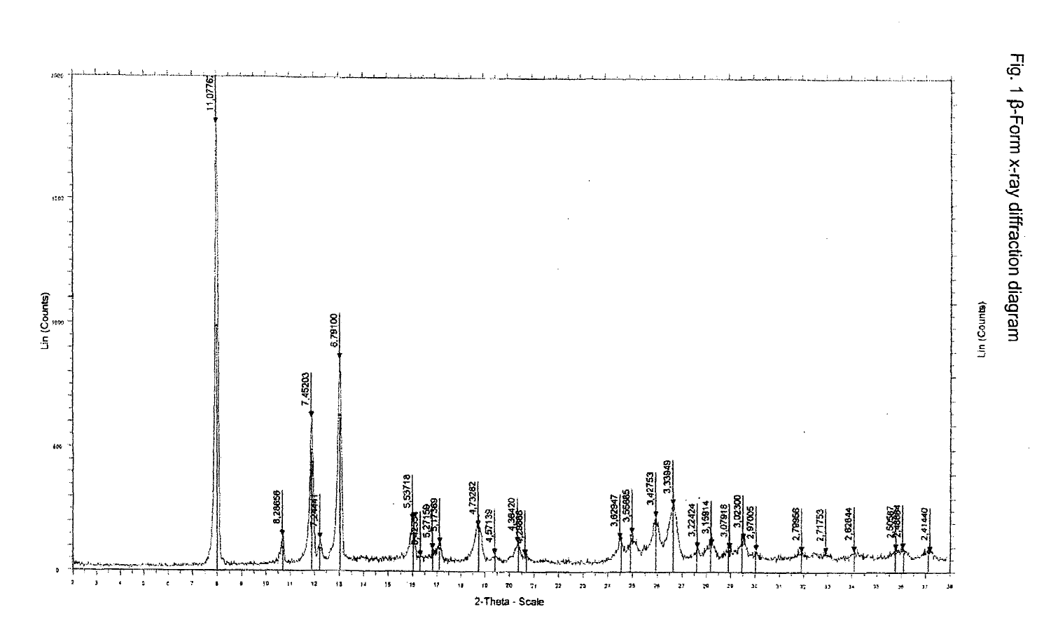

The Cu—K_{α} radiation x-ray diffraction diagram of the stable-dyeing β-form is depicted in FIG. 1. It was recorded using a computer-controlled Siemens D 5000 powder reflection diffractometer with automated aperture slit.

The dye of the formula (I) is known for example from the documents JP 50114439 and JP 55108460. The synthesis described in these patent specifications is effected by esterification of the carboxylic acid in the formula (II) by means of diethyl sulfate in o-dichlorobenzene in the presence of sodium carbonate.

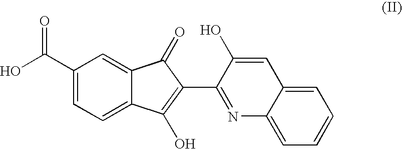

However, the dye is obtained in the unstable α-form, which has an x-ray diffraction diagram (Cu—K_{α} radiation) with lines at the following diffraction angles 2θ:

lines of high intensity:
12.8, 25.6, 27.3
lines of medium intensity:
5.1, 8.2, 8.5, 24.0, 24.3.

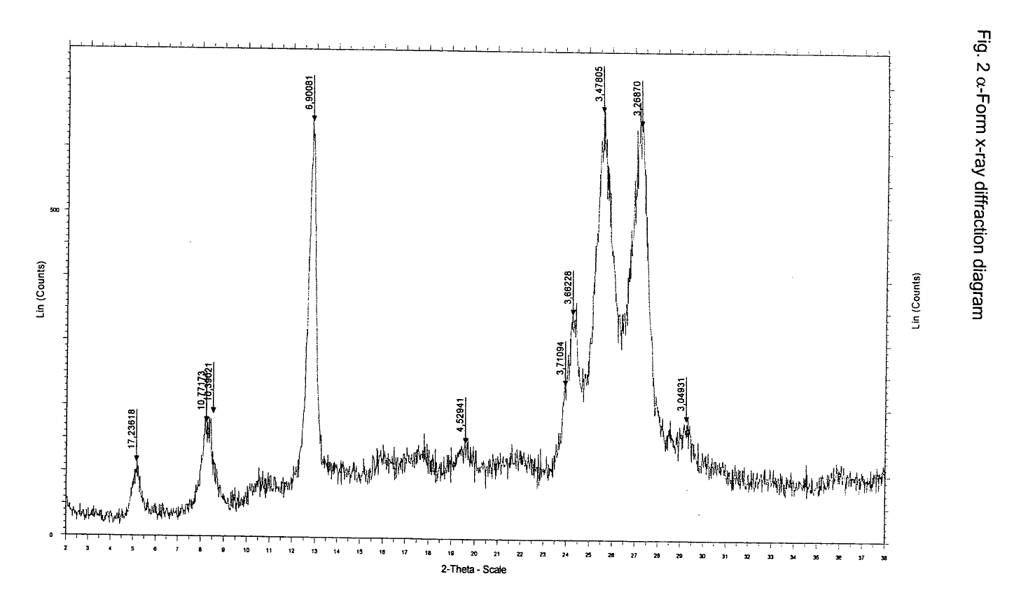

The corresponding x-ray diffraction diagram is reproduced in FIG. 2.

The dye of the formula (I) has hitherto been commercialized in the form of pulverulent or liquid preparations of the α-form. However, these preparations have appreciable defects, especially with regard to handling, and also in relation to the dyeing of textile polyester materials.

Handling issues present for example when these preparations have to be redispersed, i.e., incorporated into dyeing liquors and print pastes. Problems arise in the case of dyes in metastable crystal forms or in amorphous forms when the stable form converts, and/or the amorphous particles crystallize out, under dyeing conditions. Regions of reduced penetration of dye can result, the resulting dyeings being uneven.

By contrast, the dye in the β-form does not present any difficulties whatsoever. The β-form of the dye of formula (I) has superior wetting properties to the α-form in the making of dyeing and padding liquors and also print pastes, and is rapidly redispersed without costly and inconvenient stirring by hand or machine. The liquors and print pastes are homogeneous and dyeings on piece goods and packages are obtained free of specks, i.e., without dye deposits, in homogeneous form, that is. The present invention's β-form of the dye of formula (I), unlike the α-form, has unlimited usefulness for dyeing and printing textile materials composed of polyester, such as polyethylene glycol terephthalate and/or cellulose esters, such as cellulose acetate, or blend fabrics of these materials with wool or cellulose.

The superiority of the β-form over the α-form is also illustrated when dyeing from an aqueous dyebath under state of the art commercial conditions. They are typified by high package densities in yarn and beam dyeings, short liquor ratios, i.e., high dye concentrations, and also high shearing forces in the dyeing liquor due to high pumping-power outputs. Even under these conditions, the β-form has no tendency to agglomerate nor of depositing on the textile materials to be dyed. Homogeneous dyeings without depth of shade differences between the outer and inner coils of wound packages are thus obtained, and the dyeings do not rub off.

In addition, the superiority of the β-form is also evident when used in inks for digital ink jet printing. Inks resulting from the β-form exhibit distinct advantages not only with regard to settling behavior but also with regard to flowability.

Inks for use in digital ink jet printing, as well as the dye, further comprise from 0.1% to 20% of dispersant. Useful dispersants include for example sulfonated or sulfomethylated lignins; formaldehyde condensates of aromatic sulfonic acids; formaldehyde condensates of substituted or unsubstituted phenol derivatives; polyacrylates and copolymers thereof; styrene oxide polyethers; modified polyurethanes; reaction products of alkylene oxides with alkylatable compounds such as for example fatty alcohols, fatty amines, fatty acids, carboxamides, resin acids and also substituted or unsubstituted phenols.

Inks to be used in the continuous flow process can be adjusted to a conductivity in the range from 0.5 to 25 mS/cm by addition of electrolyte. Useful electrolytes include for example lithium nitrate and potassium nitrate. The dye inks of the present invention may comprise typical ink jet organic solvents in a total amount of 1-60% and preferably of 5-40% by weight.

The stable-dyeing β-form of dye (I) is obtained directly from a synthesis in which 3-hydroxy-2-methylquinoline-4-carboxylic acid (III) and trimellitic anhydride (IV)

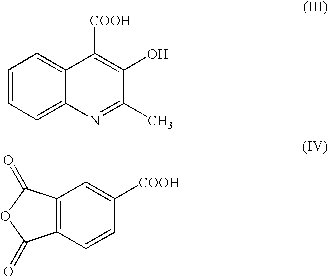

are reacted with each other in a polar solvent, for example sulfolane, dimethylformamide or DMSO, preferably sulfolane, at temperatures between 100 and 285° C., but preferably between 200 and 210° C., the water of reaction formed being constantly distilled away. The molar ratio of trimellitic acid to 3-hydroxy-2-methylquinoline-4-carboxylic acid is in the range from 0.8 to 2.0, and preferably in the range from 1.0 to 1.2.

The resulting carboxylic acid of the formula (II), which may be isolated, is esterified with an ethylating agent, preferably diethyl sulfate, in a dipolar solvent, for example sulfolane, or a mixture of a dipolar solvent with an apolar organic solvent, for example toluene, in the presence of an acid binder at temperatures from 50 to 200° C. and preferably at 140-160° C.

Useful acid binders include for example sodium carbonate, potassium carbonate, magnesium oxide, sodium acetate, potassium acetate, with sodium carbonate being particularly preferred.

The examples which follow illustrate the invention. Parts are by weight.

### PREPARATION EXAMPLE

To 1069 parts of sulfolane are added 222 parts of trimellitic anhydride before heating to 190-200° C. At this temperature, 219 parts of 3-hydroxy-2-methylquinoline-4-carboxylic acid are added. The mixture is stirred at 200-210° C. for 5.5 hours, during which the water of reaction is distilled away. The batch is then cooled down to 110° C. and 1084 parts of toluene are added to it, taking care to ensure that the temperature does not drop below 80° C. The batch is subsequently stirred at 80-85° C. for 1 hour. Then 191 parts of anhydrous sodium carbonate are added, and the batch is heated up to 100-110° C., subsequently stirred for one hour and admixed with 312 parts of diethyl sulfate added by metered addition. On completion of the addition the batch is heated to 150-160° C. for 3.5 hours during which the water of reaction/toluene mixture is distilled away. The present invention's dye (I) in the β-form is precipitated by addition of 2129 parts of methanol and cooling, filtered off and washed with methanol and hot water.

Production of an ink paste (dye content 25%): To 125 g of dye are mixed together with X weight equivalents (1 weight equivalent corresponds to 125 g) of dispersant/dispersant mixture and 375-125X g of demineralized water and ground in a stirred ball mill, so that the average particle size becomes <250 nm and the maximum particle size becomes less than 1 μm. Further additives such as biocides, defoamers, and also portions of the organic solvents used may have already been added during the grinding of the ink paste.

The ink paste thus produced, which has a dye content of 25%, has the other ink constituents (organic solvents, other additives, water) added to it before thorough mixing in a dissolver. After filtration through a commercially available paper filter (Machery-Nagel MN-614), the ink is ready to use.

### DYEING EXAMPLE

A textile fabric consisting of polyester is pad-mangled with a liquor consisting of 50 g/l of an 8% sodium alginate solution, 100 g/l of a 8-12% bean flour ether solution and 5 g/l of monosodium phosphate in water and then dried. The wet pickup is 70%.

The textile thus pretreated has an aqueous ink produced by the above-described procedure and comprising

3.5% of dye (I) in the β-form

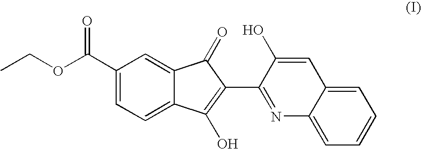

2.5% of Disperbyk 190 dispersant
30% of 1,5-pentanediol
5% of diethylene glycol monomethyl ether
0.01% of Mergal K9N biocide
58.99% of water
printed onto it using a drop-on-demand (Piezo) ink jet print head. The print is fully dried. It is fixed with superheated steam at 175° C. for 7 minutes. The print is then subjected to an alkaline reduction clear, rinsed hot and then dried.

1-8. (canceled)

9. A β-form of the dye of the formula (I) 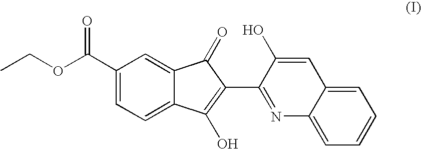
characterized by x-ray diffraction diagram (Cu—K_{α} radiation) lines at the following diffraction angles 2θ (°)
lines of high intensity:
8.0, 11.9, 13.0
lines of medium intensity:
10.7, 12.2, 16.0, 17.1, 18.7, 20.3, 24.5, 25.0, 26.0, 26.7, 29.5.

10. The process for producing the stable to dyeing β-form of dye (I) 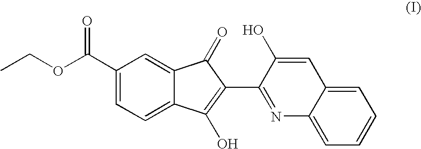
which comprises reacting a 3-hydroxy-2-methylquinoline-4-carboxylic acid (III) and trimellitic anhydride (IV) 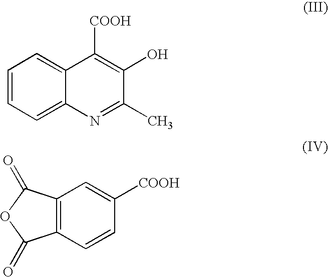
in a polar solvent and subsequent esterificating the resulting carboxylic acid of the formula (II) 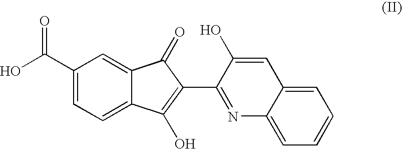
with an ethylating agent in the presence of an acid binder.

11. The process according to claim 10, wherein the reaction of compound of the formula (III) with compound of the formula (IV) is at a temperature between 100 and 285° C.,

12. The process according to claim 11, wherein the reaction of compound of the formula (III) with compound of the formula (IV) is at a temperature between 200 and 210° C.

13. The process according to claim 10, wherein the reaction of compound of the formula (II) with an ethylating agent is effected at temperatures from 50 to 200° C., in a dipolar solvent, or a mixture of a dipolar solvent with an apolar organic solvent.

14. The process according to claim 10, wherein the reaction of compound of the formula (II) with an ethylating agent is effected at temperatures from 140 to 160° C., in a dipolar solvent, or a mixture of a dipolar solvent with an apolar organic solvent.

15. The process according to claim 12, wherein the reaction of compound of the formula (II) with an ethylating agent is effected at temperatures from 140 to 160° C., in a dipolar solvent, or a mixture of a dipolar solvent with an apolar organic solvent.

16. The process according to claim 10, wherein the acid binder comprises sodium carbonate, potassium carbonate, magnesium oxide, sodium acetate or potassium acetate.

17. The process according to claim 15, wherein the acid binder comprises sodium carbonate.

18. A process for producing liquid or pulverulent dye preparation which comprises using the β-form of dye (I) according to claim 9.

19. A process for dyeing and printing textile material which comprises contacting the β-form of dye (I) according to claim 9 with the material.

20. The process as claimed in claim 19 wherein said material is composed of polyester and/or cellulose esters or blend fabrics of these materials with wool or cellulose.

21. An aqueous printing ink for textile printing by the ink jet process, comprising the β-form of dye (I) according to claim 9.
